(19) United States
(12) Patent Application Publication
(10) Pub. No.: US 2002/0109251 A1
(43) Pub. Date: Aug. 15, 2002

(54) Polymeric watercraft and manufacture method thereof

(76) Inventor: David M. Sellepack, Delton, MI (US)

Correspondence Address: Todd A. Rathe, FOLEY & LARDNER, Firstar Center, 777 East Wisconsin Avenue, Milwaukee, WI, 53202-5367, US

(21) Appl. No.: 09/903,282

(22) Filed: Jul. 11, 2001

Related U.S. Application Data
(60) Provisional application No. 60/267,880, filed on Feb. 9, 2001.

(51) Int. Cl. B29C 51/02; B29C 51/12; B29C 51/46; B29C 41/04; B29C 41/20

(52) U.S. Cl. 264/40.3; 264/503; 264/516; 264/247; 264/102; 264/553; 264/310

(57) ABSTRACT

A method for forming a three dimensional polymeric structure includes providing at least one paint layer and providing a bonding layer coupled to the at least one paint layer to form an insert having a bonding surface provided by the bonding layer. A mold having a hollow interior bounded by an interior surface is further provided. The insert is positioned within the interior along a portion of the interior surface. At least one charge of thermoplastic material is deposited into the interior. The interior is heated while the mold is rotated and rocked. As a result, the thermoplastic material melts and is deposited against the interior surface of the mold and against the bonding surface of the insert to form a three dimensional structure within the interior. The three dimensional structure is then removed from the interior of the mold.

This application claims priority under 35 U.S.C. § 119 from U.S. Provisional Patent Application Serial No. 60/267,880, filed on Feb. 9, 2001 and entitled “Polymeric Watercraft and Manufacture Method Thereof” by David M. Sellepack, the full disclosure of which is hereby incorporated by reference.

### FIELD OF THE INVENTION

The present invention relates generally to methods for manufacturing large three-dimensional polymeric structures such as watercraft. More specifically, the present invention relates to providing an exterior surface of such large three-dimensional polymeric structures with multiple colors. In particular, the present invention relates to a polymeric watercraft formed from such techniques as thermoforming and rotomolding, wherein the watercraft is providing with at least two colors along its exterior surfaces in the form of patterns, logos or camouflage.

### BACKGROUND OF THE INVENTION

Watercraft come in a wide variety of forms depending upon the particular intended use of the watercraft. Examples of watercraft include canoes, sit-in and sit-on-top kayaks, various boats, catamarans and personal flotation boards. New forms of watercraft are continuously being introduced as new water activities are discovered.

Many watercraft have a general body, such as a hull, formed from wood, metal or fiberglass. Although generally providing the necessary rigidity and durability, the use of such materials to form the body or hull of the watercraft generally results in a watercraft that is heavy, difficult to manufacture and expensive. As a result, alternative methods and materials have been developed for forming the body or hull of the watercraft. In particular, many watercraft are currently manufactured using polymeric material such as thermoplastic and thermoset materials. One common thermoplastic employed is polyethylene. To form the body or hull of the watercraft out of the polymeric material, various processes are used including thermoforming and rotomolding. Such processes are well suited for forming the large bodies or hulls of typical watercraft.

Although such watercraft formed from polymeric materials using thermoforming or rotomolding are generally lighter, easier to manufacture and less expensive as compared to the same watercraft formed from fiberglass, wood or metal, providing such polymeric watercraft with multiple colors, designs or logos on the exterior is difficult and expensive. One common method by which logos and brands are placed upon the exterior of the thermoplastic hull is mold-in or mold-on graphics wherein paint having an olefinic base (i.e. colored polyethylene paint) is applied to an interior mold surface prior to rotational molding. According to one known method, polyethylene paint is sprayed onto the interior mold surface. According to another known method, an adhesive is applied to the mold wall and a thin backing sheet carrying the polyethylene paint is positioned against the adhesive. Thereafter, the backing sheet is stripped away to leave the polyethylene paint adhered to the mold wall. During the rotomolding process, the polyethylene paint forms the logo on the exterior surface of the rotomolded polymeric watercraft. Due to cost and manufacturing complexity, this process is generally employed only for forming logos on the sides of the watercraft. Moreover, because the polyethylene paint itself melts and because the paint itself forms the exterior surface of the watercraft, the resulting logos lack sharp boundaries and are less resistant to weather. In alternative methods, designs or patterns, such as camouflage, are formed on the exterior surface of the body or hull of the watercraft using conventional paint. Although such alternative methods are commonly employed, such methods still fail to produce a sharp, high-quality design or pattern that is inexpensive, easy to create, durable and weather resistant.

Although other processes are known for forming products from polymeric materials and for providing the exterior surface of the resulting product with multiple colors, designs or logos, the use of such processes to form the relatively large bodies or hulls of typical watercraft has generally been rejected by those in the watercraft industry as being impractical and unduly expensive as compared to thermoforming and rotomolding which are well suited for forming such large at least partially hollow structures such as watercraft bodies. For example, many polymeric products are formed using a process known as injection molding. However, the use of injection molding in forming large at least partially hollow structures such as watercraft bodies or hulls is expensive and time consuming. As a result, the use of injection molding has been generally limited to forming smaller 3-dimensional products.

Another process, known to some in the automotive industry and recently discovered by Applicant is the use of thermoforming and injection cladding. U.S. Pat. No. 5,707,697 describes such a process for forming plastic automotive body panels. As generally outlined in U.S. Pat. No. 5,707,697, this process involves several steps and requires injection molding equipment. In particular, a paint coated carrier is laminated to an extremely thin backing sheet having a thickness of about 10 to 40 mils to form a laminate. The laminate and backing sheet are then thermoformed into a three-dimensional shape and are placed in an injection mold. Thereafter, liquid polymeric material is injected into the mold against the backing sheet. Due to its elevated temperature, the liquid polymeric material sufficiently softens the backing sheet to fuse to the backing sheet. After cooling, the automotive body panel is removed from the injection mold.

Although the above-described thermoforming and injection cladding process may indeed be well suited for manufacturing plastic automotive exterior and interior body panels having painted exteriors, the aforementioned process is not well suited for the manufacture of large at least partially hollow three-dimensional structures such as watercraft. In particular, the aforementioned process requires both thermoforming and injection molding steps and equipment. As a result, the process is generally too capital intensive, too time consuming and too complex.

Thus, there is a continuing need for a polymeric watercraft having a multiple color exterior surface that is easy and inexpensive to create, durable and weather resistant. There is also a continuing need for methods for creating such polymeric watercraft.

### SUMMARY OF THE INVENTION

According to one exemplary embodiment, the invention is a method for forming a three dimensional polymeric structure which includes providing at least one paint layer and providing a bonding layer coupled to the at least one paint layer to form an insert having a bonding surface provided by the bonding layer. A mold having a hollow interior bounded by an interior surface is further provided. The insert is positioned within the interior along a portion of the interior surface. At least one charge of thermoplastic material is deposited into the interior. The interior is heated while the mold is rotated and rocked. As a result, the thermoplastic material melts and is deposited against the interior surface of the mold and against the bonding surface of the insert to form a three dimensional structure within the interior. The three dimensional structure is then removed from the interior of the mold.

According to another exemplary embodiment, a method for forming a three dimensional polymeric structure includes providing at least one paint layer coupled to a bonding layer so as to form an insert and providing a mold having a hollow interior bounded by an interior surface. The insert has a bonding surface provided by the bonding layer while the mold has a parting line formed by opposing mold edges. The insert is positioned within the interior along a portion of the interior surface with a portion of the insert positioned between the opposing mold edges. The opposing mold edges are maintained at a temperature of less than the temperature of the remaining interior surface of the mold. Gas pressure within the interior is sensed and gas is selectively exhausted and supplied from and into the interior based upon the sensed gas pressure to maintain the insert in position along the interior surface.

According to yet another exemplary embodiment, a method for forming a three dimensional polymeric structure includes providing a mold having a hollow interior bounded by an interior surface, positioning an insert within the interior along a portion of the interior surface, depositing at least one charge of polymeric material in the interior, rotating and rocking the mold while the polymeric material is in a bondable condition to deposit the polymeric material against the interior surface and against the insert to form a three dimensional structure within the interior. Gas pressure within the interior is maintained high enough to maintain the insert and position along the interior surface and low enough so as to preserve integrity of the mold. At least one charge of polymeric material is deposited into the interior. The mold is rotated and rocked while the polymeric material is in a bondable condition to deposit the polymeric material against the interior surface of the mold and against the insert to form a three dimensional structure within the interior. The three dimensional structure is removed from the interior of the mold.

According to yet another exemplary embodiment, a method for forming a three dimensional polymeric structure includes providing a mold having a hollow interior bounded by an interior surface. The mold has a part line formed by opposing mold edges. An insert is positioned within the interior along a portion of the interior surface with a portion of the insert extending between the opposing mold edges. At least one charge of polymeric material is deposited into the interior. The mold is rotated and rocked while the polymeric material is in a bondable condition to deposit the polymeric material against the interior surface of the mold and against the insert to form a three dimensional structure within the interior. The three dimensional structure is removed from the interior of the mold.

### BRIEF DESCRIPTION OF THE DRAWINGS

FIG. 1 is a perspective view illustrating a watercraft of the present invention.

FIG. 2 is a sectional view of the watercraft of FIG. 1 taken along lines 2-2.

FIG. 3 is a flow chart illustrating a process for forming the watercraft of FIG. 1.

FIG. 4 is a perspective view of a first alternative embodiment of the watercraft of FIG. 1.

FIG. 5 is a sectional view of the watercraft of FIG. 4 taken along lines 4-4.

FIG. 6 is a flow chart illustrating a process for forming the watercraft of FIG. 4.

FIG. 7 is a top perspective view of a second alternative embodiment of the watercraft of FIG. 1.

FIG. 8 is a bottom perspective view of the watercraft of FIG. 7.

FIG. 9 is a top plan view of the watercraft of FIG. 7.

FIG. 10 is a side elevational view of the watercraft of FIG. 7.

FIG. 11 is a bottom plan view of the watercraft of FIG. 7.

FIG. 12 is a left end elevational view of the watercraft of FIG. 7.

FIG. 13 is a right end elevational view of the watercraft of FIG. 7.

FIG. 14 is a top plan view of a third alternative embodiment of the watercraft of FIG. 1.

FIG. 15 is a flow chart illustrating a process for forming the watercraft of FIGS. 7-14.

### DETAILED DESCRIPTION OF THE PREFERRED EMBODIMENTS

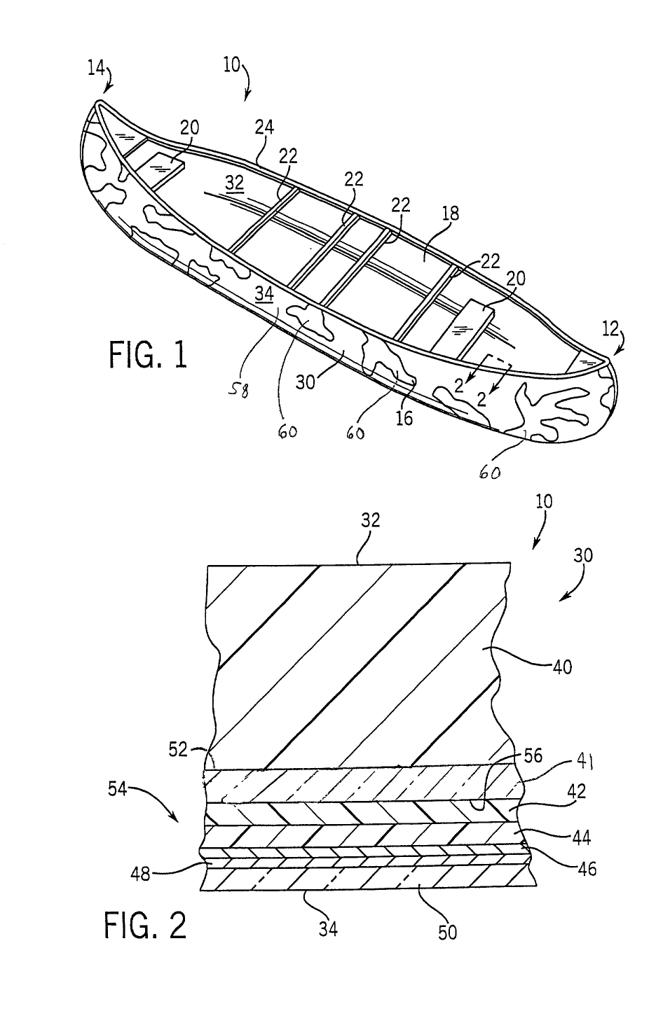

FIG. 1 is a perspective view of a watercraft 10 of the present invention. In the exemplary embodiment illustrated, watercraft 10 comprises a canoe having a front or bow 12 and having a rear or stern 14. Watercraft 10 has a hull 16 which forms an interior or cockpit 18. Although not essential, watercraft 10 additionally includes seating supports 20, cross braces 22 and rim 24. Seating surfaces 20, cross braces 22 and rim 24 are conventionally known and will not be described in great detail.

Hull 16 generally consists of a single wall 30 having an interior surface 32 and an exterior surface 34. Interior surface 32 forms cockpit 18 where the person using watercraft 10 may rest or store possessions. In alternative watercraft, cockpit 18 may be partially covered or may extend above a deck such as in a sit-on-top kayak. Exterior surface 34 extends from bow 12 to stern 14 and comes in contact with the water. Exterior surface 34 is provided with a plurality of colors in the form of patterns, logos, designs or camouflage. As a result, watercraft 10 has a pleasing aesthetic appearance and, depending on the colors and patterns chosen, may be used in such activities as hunting, fishing and wildlife observation.

FIG. 2 is a sectional view of wall 30 of hull 16 taken along lines 2-2 of FIG. 1. As best shown by FIG. 2, wall 30 generally includes polymeric layer 40, olefinic backing layer 41, polymeric layer 42, protective layer 44, backing layer 46, pigment layer 48 and protective layer 50. Polymeric layer 40 extends from bow 12 to stern 14 of watercraft 10 and generally forms the bottom and keel as well as the sides of watercraft 10. Polymeric layer 40 has a sufficient thickness so as to provide the majority of structural strength and rigidity required by wall 30 and hull 16. Layer 40 preferably has a thickness of at least 0.25 inches. Although layer 40 is illustrated as comprising a single material, layer 40 may alternatively include a copolymer (such as PP/PE) or a reinforced polymer (such as glass-reinforced polyethylene) or a plurality of similar polymeric materials fused to one another. For example, layer 40 may alternatively comprise a skin-foam-skin configuration wherein the skin-foam-skin structure provides the required structural rigidity and strength for wall 30 and hull 16. In such a skin-foam-skin embodiment, one of the skin layers would be equivalent to layer 40. Layer 40 has a surface 52 opposite surface 32 which is coupled to layer 41. Surface 52 preferably includes a olefinic material such as polyethylene. In the exemplary embodiment, the entirety of layer 40 includes polyethylene. As a result, layer 40 can be easily formed into the shape of hull 16, is less expensive, and yet provides the required rigidity and strength required for hull 16 of watercraft 10.

Layers 41-50 are preferably precoupled to one another before being coupled to layer 40. Layer 41 serves as a bonding layer and comprises a thermoformable backing sheet compatible with the adjacent surfaces of layers 40 and 42. In the exemplary embodiment where surface 52 of layer 40 includes polyethylene and in which surface 56 of layer 42 comprises a chlorinated polyolefin, layer 41 preferably comprises polyethylene or another thermoplastic polyolefin. Layer 41 preferably has a thickness from about 10 to 40 mils and is fused to layers 40 and 42.

Layers 42-50 are preferably preformed as a thermoformable laminate 54. Laminate 54 has a thickness of about 1 to 2 mils. The laminate 54 is preferably configured to overlie the entirety of layer 41 such that laminate 54 extends from bow 12 to stern 14 so as to provide exterior surface 34 with multi-colored pattern or design. In the exemplary embodiment, laminate 54 provides watercraft 10 with a camouflaged pattern.

Layer 42 comprises a polymeric layer which is preferably compatible for bonding with the polymeric layer existing along at least surface portions of layer 41. In the exemplary embodiment, layer 42 has at least a surface 56 including an olefinic material which is compatible with the olefinic material of layer 41. As a result, layers 41 and 42 fuse to one another to securely couple laminate 54 to layer 41. Surface 56 preferably comprises a chlorinated polyolefin (CPO), a reactive cross link adhesive with polyolefin. Chlorinated polyolefin is a covalent adhesive and has an adhesive activation temperature of about 270 degrees Fahrenheit. For purposes of this disclosure, adhesive activation temperature shall mean the temperature at which material attains a state of adhesiveness or fusibility. For covalent adhesives, the adhesive activation temperature is the temperature at which molecular sites are activated such that the sharing of electrons may occur such that the material has an adhesive quality. In contrast, ionic adhesives form less reliable bonds. For non-covalent adhesive polymers, the adhesive activation temperature is the temperature at which the polymer has sufficiently melted so as to be able to fuse to or blend with another polymer.

Layers 44 and 50 encapsulate layers 46 and 48 therebetween to protect layers 46 and 48. In particular, layer 44 adheres to layers 42 and 46. Layer 50 protects layers 46 and 48 from abrasion, wear, sunlight and weather. As a result, the multiple colors and patterns provided by layers 46 and 48 are encapsulated and protected such that the exterior 34 of watercraft 10 retains its original high-quality, sharp colored patterns, even after exposure to sunlight and exposure to rocks and other abrasive materials typically encountered by the bottom and sides of watercraft 10 during use. In the exemplary embodiment, layers 44 and 50 each preferably comprise an acrylic material. Examples of such layers or coatings (“clear coat”) are described in U.S. Pat. No. 5,707,697, the full disclosure of which is hereby incorporated by reference. Layer 50 preferably comprises an acrylic with a flouropolymer such as polyvinylidene fluoride (PVDF). Layer 50 is at least partially transparent and is preferably completely transparent to allow the multiple colors and patterns provided by layers 46 and 48 to be seen. Layer 50 is also preferably resistant to ultraviolet light. Moreover, in particular applications, layer 44 may be omitted depending upon the material qualities of layer 42.

Layers 46 and 48 provide the multi-colored pattern or design of laminate 54. Each of layers 46 and 48 preferably include PVDF. Layer 46 preferably comprises a backing layer of colored dye, ink, pigment, or solid coloring matter (hereafter “paint”) which provides a base color. Examples of such paint (“color or tint coat”) are described in U.S. Pat. No. 5,707,697, the full disclosure of which is hereby incorporated by reference. Pigment layer 48 comprises a layer of paint of multiple colors which provides the pattern. As shown by FIG. 1, layers 46 and 48 are selected so as to form a camouflage pattern having a solid backing color 58 and at least different color in the form of a plurality of environmental vegetation shapes 60. The exact color chosen for background 58 and shapes 60 are generally selected from the colors of olive, brown, green and the like, depending upon the particular environment in which the camouflage is to be used. Such environmental vegetation would include grasses, leaves, plants such as cattails, or various other vegetation.

Depending on the particular application, layer 46 or layer 48 may be omitted. Moreover, layer 48 may have any of a number of different colors and patterns. Moreover, although less desirable, in particular applications, laminate 54 may extend on only portions of exterior surface 34 between bow 12 and stern 14.

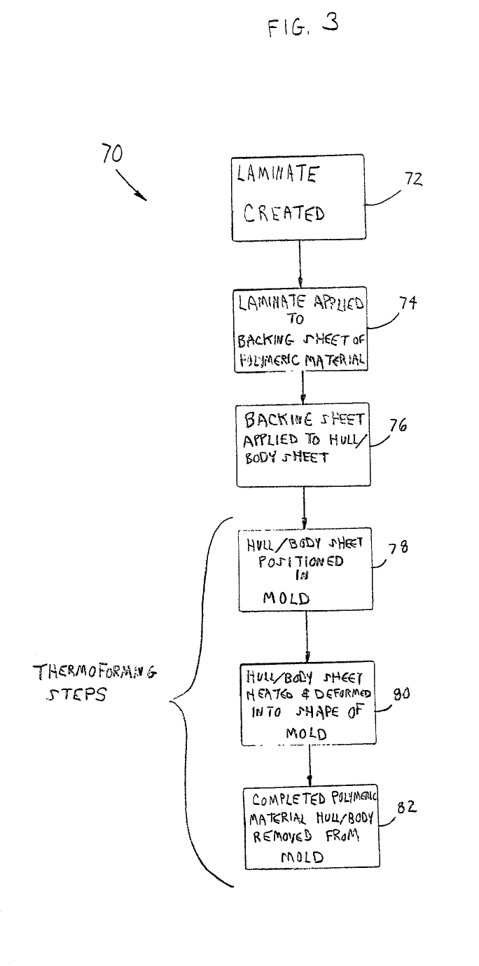

FIG. 3 is a flow chart depicting process 70 employed to form watercraft 10. Process 70 generally includes steps 72, 74, 76, 78 and 80. In step 72, laminate 54 (shown and described with respect to FIG. 2) is created. Laminate 54 is generally created by depositing layers 42-50 upon a thin carrier film or sheet. Typically, the carrier sheet is made from polyester or a similar material. This sheet serves as a substrate for depositing layers 42-50. This carrier sheet is later removed prior to completion of the final product.

Once laminate 54, including layers 42, 44, 46, 48 and 50, is formed, laminate 54 is applied to backing sheet 41 as indicated by step 74. In particular, backing sheet 41 and laminate 54 are pressed into contact with one another while being heated to a temperature sufficient to activate sites within layer 42 for forming an adhesive in layer 42 of laminate 54. As a result, laminate 54 is fused to backing sheet 41. Once laminate 54 is fused to backing sheet 41, the carrier sheet is typically removed. The securement of the backing sheet to the laminate is described in greater detail in U.S. Pat. No. 5,707,697, the disclosure of which is incorporated by reference. The composite laminate and backing sheet preferably utilized in forming watercraft 10 is supplied by Avery Dennison Corporation.

As indicated by step 76, the backing sheet and the coupled laminate are then applied to a hull body sheet which provides layer 40 (shown and described in FIG. 2). In particular, a hull body sheet of polymeric material is extruded. While this generally planar elongate sheet of polymeric material, preferably polyethylene, is at an elevated temperature at or above the melting point of backing sheet 41, the hull/body sheet and backing sheet 41 are pressed into contact with one another such that the two adjacent layers fuse to one another. Rollers are preferably utilized to press backing sheet 41 against layer 40 in the form of the hull/body sheet.

As indicated by steps 78-82, the hull/body sheet, including layers 40, 41, 42, 44, 46, 48 and 50, is then thermoformed into a 3-dimensional shape such as the shape of watercraft 10 shown in FIG. 1. In particular, the hull/body sheet is positioned in a mold and is heated to an elevated temperature high enough such that the hull/body sheet is formable yet below the melting point of the material forming the hull/body sheet. At the same time, a hydraulic press deforms the hull/body sheet. In an alternative embodiment, a vacuum or pressure source may be used to deform the generally planar hull/body sheet into the 3-dimensional shape of the mold. Lastly, as indicated by step 82, the hull/body sheet is allowed to cool and the resulting 3-dimensional hull/body is removed from the mold. Thereafter, the sheet is trimmed as necessary and additional structures are added to it such as the aforementioned cross braces 22, seating surfaces 20 or rim 24.

In the exemplary embodiment illustrated, laminate 54 comprises a modified AVLOY Series A dry paint film sold by Avery Dennison Corporation. The film is modified so as to have a reduced overall film thickness and so as to include a damping agent. In particular, in a camouflage application, it is desired that the multi-colored camouflage pattern not be shiny or glossy but be rather dull. To achieve this, the outermost clear coat of PVDF is modified to include a conventionally known damping agent and to have a reduced thickness.

In the exemplary embodiment, layers 42 and 44 are generally formed as a single polar sheet known as a thermoplastic tie coat (also known as a “size coat”) having one side with a CPO and the other side with an acrylic coating. This single sheet generally has a thickness of approximately 0.1 to approximately 0.2 mils. Layer 46 has a thickness of approximately 0.2 mils, while layer 48 has a thickness of approximately 0.15 mils. Exterior most layer 50 has a thickness of approximately 0.3 mils. A more detailed description of conventional laminate layers and materials is disclosed in U.S. Pat. No. 5,707,697, the full disclosure of which is hereby incorporated by reference. Although laminate 54 has been described specifically for providing a camouflage pattern for watercraft 10, laminate 54 may have alternative configurations and colors for providing watercraft with a single tone or multi-tone exterior color or color pattern. Laminate 54 may also have various layers and thicknesses for providing watercraft 10 with a high gloss or sheen depending on the desired appearance characteristics for watercraft 10.

The above-described process is well suited for manufacturing large 3-dimensional structures economically and efficiently. In particular, the above process enables laminate 54 to be joined to both backing sheet 41 and the relatively thick flat or planar structural hull/body sheet 40 prior to any deformation of laminate 54, backing sheet 41 or hull/body sheet 40. As a result, the above process enables such large thick planar composite sheets including laminate 54, backing sheet 41 and thermoformable sheet 40 to be pre-made ahead of time in large quantities prior to being deformed into a three-dimensional product by thermoforming. Consequently, all of the steps required to produce a large polymeric three-dimensional product, except for a relatively quick and inexpensive thermoforming step, may be completed ahead of time to enable a faster reaction to changes in production requirements and consumer demand. Moreover, because such composite thermoformable sheets are generally flat or planar, such sheets may be compactly stacked upon one another when being stored. Furthermore, the above-identified process produces a high quality camouflage pattern on large structural objects, such as watercraft 10, quickly and cost effectively as compared to conventionally known methods for creating such camouflage patterns.

Although the above-described process constitutes a significant advance in the art for creating large three-dimensional structures having exterior surfaces provided with either multiple colors arranged in various patterns or camouflage or large three-dimensional structures having a high gloss exterior, several deficiencies have been identified with this process. In particular, it has been found that the hull/body sheet providing layer 40 and backing sheet 41 are frequently insufficiently fused to one another. As a result, air bubbles or pockets are created between layers 40 and 41. In severe cases, layers 40 and 41 separate. As a result, the product produced by the above-identified process lacks optimal quality.

Moreover, it has also been found that laminate 54 frequently undergoes excessive shrinkage during cooling after layers 40 and 41 have been joined to one another. In particular, during the formation of watercraft 10 utilizing process 70, laminate 54 shrunk 10.6%. This excessive shrinkage of laminate 54 reduces the overall quality of the exterior appearance provided by laminate 54. Moreover, the extra square footage of laminate 54 required to account for the excess shrinkage increases the cost of manufacturing such large 3-dimensional products such as watercraft 10.

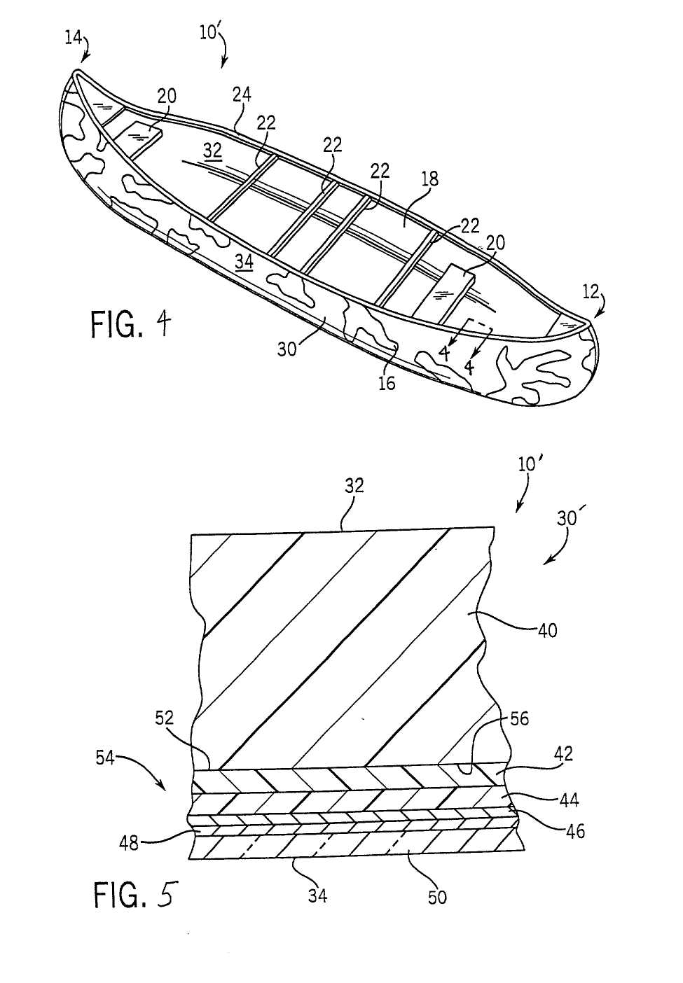

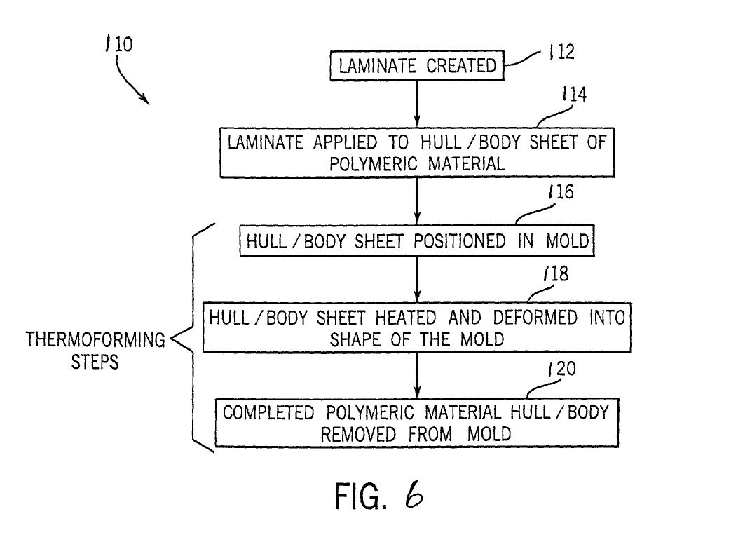

FIGS. 4 and 5 illustrate watercraft 10′, an alternative embodiment of watercraft 10 shown and described with respect to FIGS. 1 and 2. Watercraft 10′ is manufactured using process 110, shown and described with respect to FIG. 6 hereafter. Watercraft 10′ manufactured using process 110 is generally less expensive to manufacture and of a higher quality as compared to watercraft 10. Watercraft 10′ is similar to watercraft 10 except that watercraft 10′ omits the backing sheet or layer 41 such that layer 42 fuses directly to layer 40. For ease of discussion, those elements of watercraft 10′ which are similar to watercraft 10 are numbered similarly.

FIG. 6 is a flow chart depicting process 110 employed to form watercraft 10′. As shown by FIG. 6, process 110 generally includes steps 112, 114, 116, 118 and 120. In step 112, laminate 54 (shown and described with respect to FIG. 5) is created. Laminate 54 is created by depositing layers 42-50 upon a thin carrier film or sheet formed from material such as polyester and the like. This sheet serves as a substrate for the deposition of such layers. Once laminate 54, including layers 42, 44, 46, 48 and 50, is formed, laminate 54 is applied to a hull/body sheet of polymeric material such as layer 40 (shown in FIG. 2) as indicated by step 114. After laminate 54 is applied to the hull/body sheet, the carrier film or sheet is preferably removed.

In the exemplary process, the hull/body sheet of polymeric material is first allowed to cool after being extruded and prior to being joined to laminate 54. Although the melting point of pure high density polyethylene is approximately 266 degrees Fahrenheit, the hull/body sheet of high density polyethylene is preferably heated to a temperature of at least about 350 degrees Fahrenheit to ensure a homogenous viscous blend (similar to that of a gel or toothpaste) of melted polyethylene during extrusion. As will be appreciated, the extrusion of the high density polyethylene is easier as the temperature of the polyethylene is increased. In the exemplary process, the high density polyethylene is extruded at a temperature of approximately 500 degrees Fahrenheit. Once extruded, the hull/body sheet of high density polyethylene is permitted to cool to a temperature such that the sheet undergoes a majority of shrinkage prior to being joined to laminate 54. In particular, the hull/body sheet of polymeric material is allowed to cool down from its approximately 500 degrees Fahrenheit extruding temperature to approximately 180-190 degrees Fahrenheit. As the hull/body sheet cools from 500 degrees Fahrenheit to its melting point of approximately 266 degrees Fahrenheit, the hull/body sheet undergoes approximately 40% shrinkage. As the hull/body sheet further cools from melting point of approximately 266 degrees to a temperature of approximately 180-190 degrees, the sheet undergoes an additional 50% shrinkage such that the hull/body sheet has undergone 90-95% of its shrinkage when at 180-190 degrees. By allowing the hull/body sheet to cool to approximately 180-190 degrees Fahrenheit prior to being joined to laminate 54, excessive shrinkage of laminate 54 is avoided.

While hull/body sheet is preferably warm (180-190 degrees), layer 42 of laminate 54 is adhered to layer 40 provided by the hull/body sheet. Layer 42 of laminate 54 is heated to at least an adhesive activation temperature of layer 42 (approximately 270 degrees Fahrenheit for chlorinated polyolefin). In an exemplary process, layer 42 is heated to approximately 300 degrees Fahrenheit. At this temperature, layer 42 sufficiently adheres to layer 40 for thermoforming. In alternative applications, the hull/body sheet may be cooled to a lower temperature and then reheated to 180-190 degrees Fahrenheit. Because the hull/body sheet providing layer 40 is allowed to sufficiently cool and to complete a majority of its shrinkage prior to being joined to layer 42, laminate 54 is not itself exposed to excessive shrinkage.

In an alternative process, the sheet is allowed to cool from its extrusion temperature (at least approximately 350 degrees Fahrenheit for high density polyethylene) to a temperature slightly greater than 270 degrees Fahrenheit, a temperature sufficiently high to activate the chlorinated polyolefin when laminate 54 is joined to the hull/body sheet. Because laminate 54 is joined to the extruded hull/body sheet of polymeric material already after the sheet has been allowed to cool, laminate 54 itself is not exposed to the high temperatures required to melt and extrude the polymeric material. Because surface 56 of layer 42 and surface 52 of layer 40 are each preferably formed from compatible material such as an olefinic material, surfaces 56 and 52 are preferably fused to one another. Rollers are preferably utilized to press laminate 54 against layer 40.

Because layer 40 has a sufficient thickness so as to provide a majority, if not the entirety of the structural rigidity and strength required by wall 30 of hull 16, the hull/body sheet resulting from the fusion of laminate 54 to layer 40 requires no additional steps other than simply forming the hull/body sheet into the shape of the watercraft 10. In particular, the laminate is coupled to the polymeric sheet and the resulting hull/body sheet is then formed into the watercraft. Since the bulk and weight of the hull/body sheet used to form watercraft 10′ must be large due to the size of the watercraft 10′, the elimination of any additional steps saves shipping and transportation costs, reduces manufacturing complexity and reduces costs.

As indicated by step 116, the hull/body sheet (joined laminate 54 and layer 40) is positioned in a thermoforming mold in the shape of the watercraft to be formed (watercraft 10′). The hull/body sheet is then heated and deformed such that the one side of the sheet corresponds to the interior mold surface. In one particular application, the hull/body sheet is formed by a hydraulic press which deforms the hull/body sheet. In an alternative embodiment, a vacuum or pneumatic pressure source is utilized to draw the hull/body sheet into the shape of the mold as indicated by step 118.

Finally, as indicated by step 120, the completed polymeric material hull/body is removed from the mold. Thereafter, the sheet is trimmed as necessary and additional structures are added to it such as the aforementioned cross braces 22, seating surfaces 20 or rim 24.

Process 110, utilized to form watercraft 10′, reduces or eliminates the aforementioned deficiencies associated with process 70. Because process 110 eliminates the backing sheet providing layer 41, process 110 requires fewer steps. As a result, process 110 is less complex and less expensive. Furthermore, by eliminating layer 41, process 110 enables the relatively thick thermoformable hull/body sheet providing layer 40 to be directly joined to layer 42 of laminate 54. As a result, less material is required, further reducing costs. In addition, because layer 42 of laminate 54 includes one or more materials which activate to an adhesive state at a much lower temperature than the thermoplastic melting point of the previously required backing sheet 41, layer 40 more easily and more reliably joins or fuses to layer 42 and laminate 54. As a result, process 110 substantially reduces or eliminates the formation of bubbles between laminate 54 and layer 40 and further minimizes the risk of separation of laminate 54 from layer 40.

Moreover, because layer 42 of laminate 54 joins or adheres to layer 40 at a much lower temperature as compared to the previous required backing sheet 41, laminate 54 and hull/body sheet 40 may be joined to one another while one or both of laminate 54 and layer 40 are at a much lower temperature. The Applicants of the present application have discovered that the excess shrinkage of laminate 54 in process 70 is a result of a large degree of shrinkage of layer 40 as it cools after being extruded and joined to laminate 54. By allowing layer 40 to cool from its relatively high extrusion temperature and to substantially complete a majority of its shrinkage during cooling prior to being joined to laminate 54, Applicants have discovered that excessive shrinkage of laminate 54 can be avoided. At the same time, because layer 42 of laminate 54 has a much lower adhesive activation temperature as compared to layer 41, layer 42 of laminate may be securely and reliably joined to layer 40 after layer 40 has cooled from its extrusion temperature and after layer 40 has undergone a substantial portion of its inherent shrinkage. Thus, process 110 enables large 3-dimensional bodies or structures to be formed with fewer steps, fewer layers, and less laminate shrinkage while producing a higher quality structure having fewer bubbles, separation points or other defects.

In alternative processes in which layer 42 and layer 40 are composed of alternative materials or mixtures of materials, the temperature at which layers 40 and 42 are joined to one another may be varied. Preferably, the polymeric material chosen for layer 40 as well as the material chosen for layer 42 of laminate 54 should be selected such that layer 40 may undergo a substantial amount of its shrinkage during cooling prior to being joined to layer 42 of laminate 54 while at the same time have an elevated temperature sufficient so as to be joined to layer 42 of laminate 54. In alternative embodiments, surface 56 of layer 40 may alternatively be provided with one or more materials formed as a layer or dispersed along surface 56, wherein the one or more materials have an adhesive activation temperature which permits layer 40 to cool after being extruded and to complete a substantial portion of its inherent shrinkage prior to being joined to laminate 54 while one or more materials of surface 54 are still in an adhesive or fusing state. Although less desirable, process 110 could alternatively be modified to include the provision of one or more additional layers between layers 42 and 40, wherein at least portions of the exterior surfaces of the one or more layers disposed between layers 40 and 42 have a lower heat activation temperature as compared to the thermoplastic melting point of layer 40 so as to permit layer 40 to undergo a majority of its shrinkage prior to being joined to laminate 54 and the additional one or more intervening layers.

According to one process, layers 40 and 42 are joined as layer 42 is cooling after being extruded. Alternatively, process 110 may permit layer 40 to be cooled to an even lower temperature. In such an alternative process, layer 40 would then be reheated. Likewise, in addition to layer 42 being at a temperature at or above the heat activation temperature of layer 42, layer 40 may alternatively be heated (or cooled down) to a temperature above the adhesive activation temperature of layer 42 just prior to being brought into contact with layer 42.

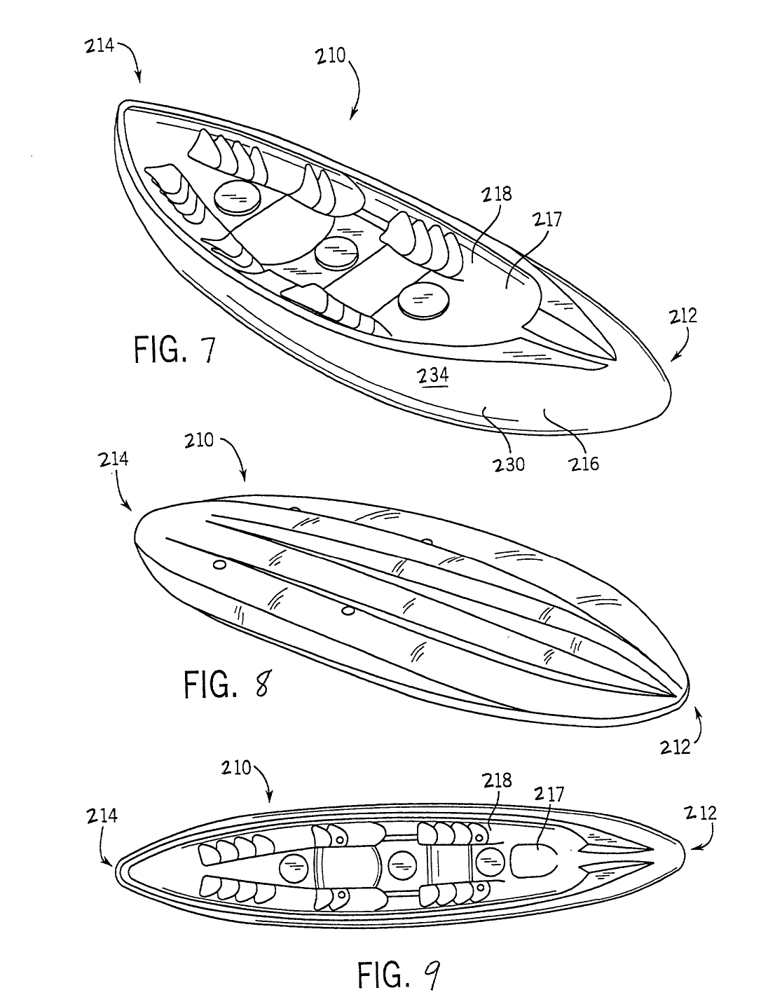

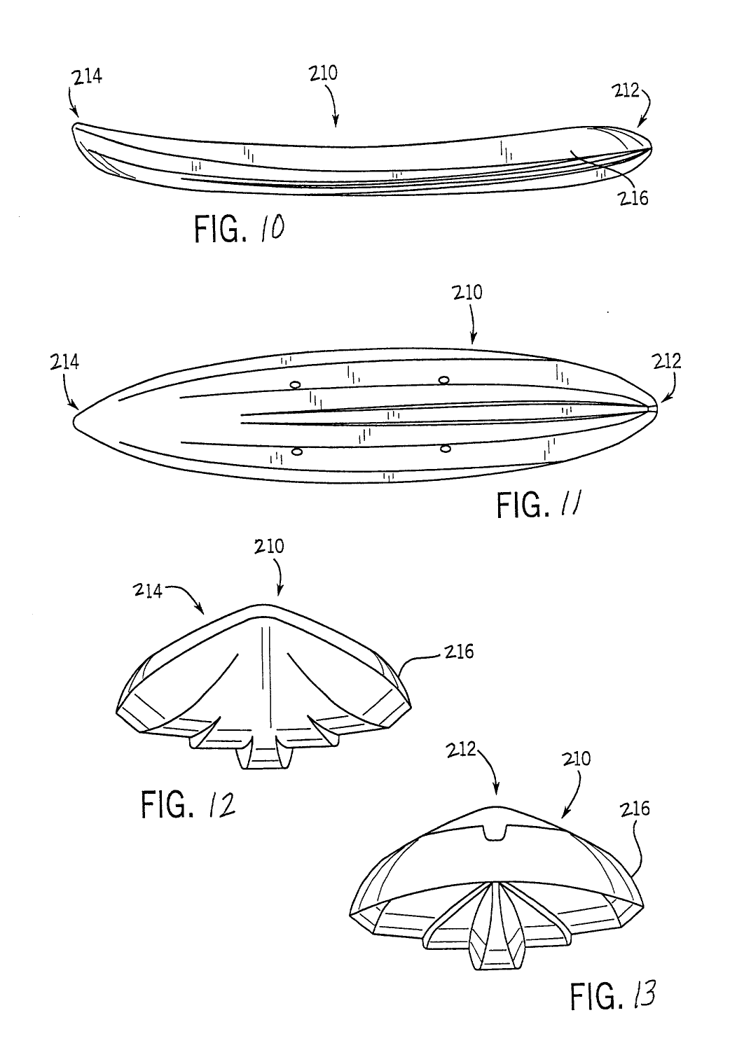

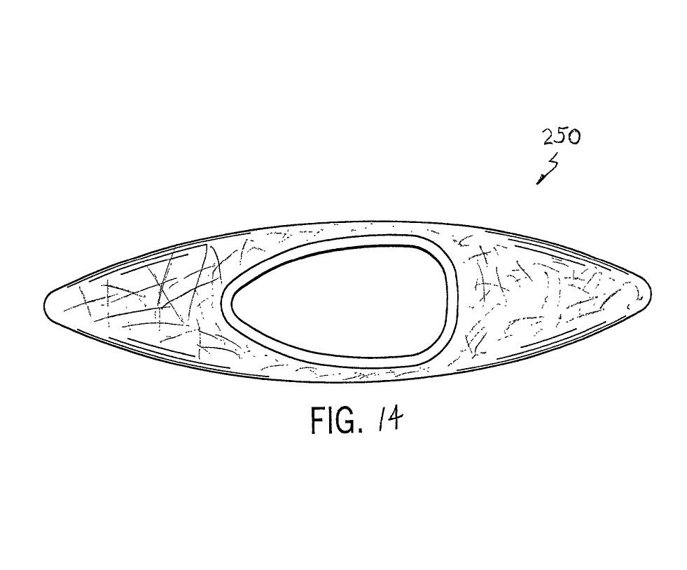

FIGS. 7-13 illustrate watercraft 210, an alternative embodiment of watercraft 10′ shown in FIG. 4. Watercraft 210 comprises a conventionally known sit-on-top kayak having a bow 212, a stern 214 and a hull 216, and a deck 217 forming an interior cockpit 218. Hull 216 and deck 217 are preferably integrally molded as single unitary body using a rotomolding process. Hull 216 includes a wall 230 that extends from bow 212 to stern 214. The general exterior shape of hull 116 and deck 117 (not the composition of wall 230) is shown in U.S. application Ser. No. 6,178,912, the full disclosure of which is hereby incorporated by reference.

Wall 230 has an exterior surface 234 provided with a plurality of colors in the form of either a pattern, design or a logo. In the exemplary embodiment, surface 234 is provided with a camouflage pattern generally consisting of the colors of olive, brown, green, and the like, depending upon the particular environment in which the camouflage is to be used. The pattern may have such different colors in the shape of environmental vegetation. Exterior surface 234 is provided by wall 230. The composition of wall 230 is substantially identical to the composition of wall 30 shown in FIG. 5. However, in applications where watercraft 210 is rotomolded, layer 42 is bonded to an additional thin-gauge polymeric material having a thickness of about 20 mils (0.020 inches) disposed between layer 42 and layer 40. The thin-gauge polymeric material preferably has a thickness to enable laminate 54 and the support layer to be positioned within the mold interior as an insert along the wall of the mold as will be described in greater detail with respect to FIG. 15.

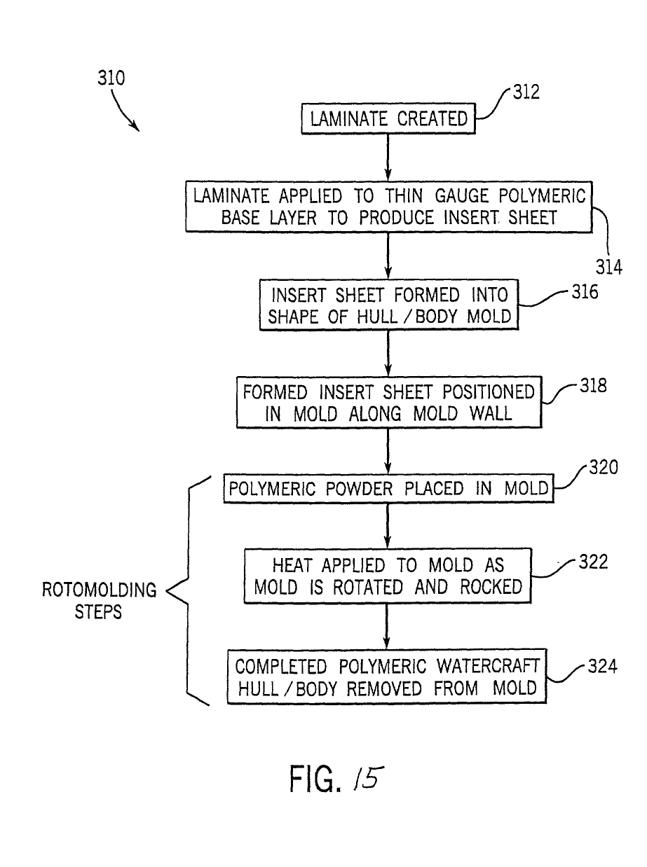

FIG. 14 illustrates a sit-in kayak 250 having the deck portion of its hull formed from a wall substantially identical to wall 30 shown in FIG. 5. As best shown by FIG. 14, the hull wall forming the deck has a pleasing aesthetic multi-colored pattern or design. In this exemplary embodiment, the pattern and colors chosen are to form a camouflage pattern similar to that of grass.

FIG. 15 depicts rotomolding process 310 for forming watercraft 210 and 250 shown in FIGS. 6 through 14. Alternatively, process 310 may be employed to form watercraft 10 or other rotomolded watercraft. As shown by FIG. 15, process 310 generally includes steps 312, 314, 316, 318, 320, 322 and 324. In step 312, a laminate similar to laminate 54 (shown in FIG. 2) is created. This laminate preferably includes layers 42 through 50 as previously described. Once the laminate is created in step 312, the laminated is applied to a thin gauge polymeric base layer to produce an insert sheet as set forth in step 314. The thin gauge polymeric base layer preferably has a sufficient thickness as to retain the shape of laminate 54 after the joined insert sheet has been formed into the shape of the hull or body mold as indicated in step 316. The base layer preferably has a thickness of about 20 mils. In the exemplary embodiment, the thin gauge polymeric base layer has an outer most surface including an olefinic material, preferably polyolefin, which is fused to laminate 54. Preferably, the thin gauge polymeric base layer is fused the laminate 54 in a manner similar to that described with respect to process 110.

Once the insert sheet is formed into the shape of the hull or body mold as indicated by step 316, the insert sheet is preferably formed by using a hydraulic press and a hull/body mold. Alternatively, the insert may be formed using vacuum or other deforming methods. During the formation, the insert sheet is preferably heated.

As indicated by step 318, the formed insert sheet is removed from the hull/body mold and repositioned in a rotational molding mold along the wall of the rotational molding mold. According to one exemplary process, the insert is provided with a lip or flange which is captured between opposing halves or opposing mold edges of the rotational molding mold to retain the formed insert in place against the interior wall surface of the rotational molding mold. Preferably, portions of the mold part line adjacent the lip or flange of the insert are sufficiently insulated to at least delay the onset of melting of the polymeric material forming the flange until the at least one rotomolding charge polymeric material inside the mold has melted about and adjacent to the insert to hold the insert in place. In one exemplary embodiment, insulating TEFLON (polytetrafluoroethylene) tape applied to portions of the mold part line which extend adjacent to the flange of the insert. Alternatively, other insulative materials may be employed along the adjacent portions of the mold part line. Moreover, in lieu of the insulative material being releasably secured or coupled to the mold at the part line, such insulative materials may be alternatively be integrally formed or nonremovably coupled to the mold. Although less desirable, the adjacent portions of the mold part line may alternatively be insulated of one or more layers of insulative material embedded within the mold wall rather than at the surface of the mold part line or may alternatively be cooled by various means such as internal fluid passages in the mold wall or the like.

According to another exemplary process, the rotational molding mold is provided with a vent selectively sized so as to release pressure build up within the mold at a rate sufficiently large such that the rotational mold does not rupture or suffer an integrity impairment, yet slow enough such that the interior of the rotational mold has a sufficient pressure so as to hold surface 34 of layer 50 against the interior mold surface to avoid sinks as the formed insert slightly shrinks and to avoid unintended movement of the insert within the mold during rocking and rolling of the mold. In one particular embodiment, the vent is provided with a pressure regulating device. The amount of pressure maintained within the rotational mold is above atmosphere pressure and depends largely upon the thickness of the insert and its shrinkage characteristics.

In particular applications, air or other gas is supplied to the interior of the mold to ensure at least a minimum amount of pressure within the mold during the entire rotationally molding process. In such a process, the rotational mold is preferably provided with a pressure valve such as pop-it valve to regulate a maximum amount of pressure within the mold. According to one exemplary process, a pressure of approximately 5 psi to approximately 16 psi is maintained within the mold. This pressure has been found high enough to hold the insert in place yet low enough so as to avoid distortion of the mold or tool which is preferably aluminum. In yet another alternative process, selected interior surfaces of the mold are provided with vacuum ports which draw and hold the insert in place during rotational molding. When positioned within the rotational molding mold, surface 34 of layer 50 is positioned against the interior mold surface.

As indicated by steps 320, 322 and 324, watercraft 210 is completed following the outlined rotomolding steps. In particular, polymeric material, preferably polyethylene, is placed within the rotational molding mold. Heat is applied to the mold as the mold is rotated and rocked. As a result, the polymeric powder melts to a bonding state and forms along the interior mold to form a layer similar to layer 40 (shown in FIG. 2) which becomes fused to the polymeric base layer of the insert sheet. The above process contemplates use of a thermoplastic polymeric material wherein the polymeric material is melted to attain a bonding state. Alternatively, a charge of a thermoset polymeric material may be employed, wherein the polymeric material attains a bonding state by chemical activation, heat activation or other activation devices or materials. Moreover, in lieu of rotating and rocking the mold to deposit the polymeric material against the insert and against the interior of the mold, expanding foam-like polymeric material may be employed to form a polymeric wall adjacent to and about the insert or a polymeric layer at least partially encapsulating an expandable material may be employed, wherein expansion of the expandable material forces the polymeric skin or layer against the interior of the mold wall adjacent to and about the insert.

In particular applications, step 320 includes the deposition of multiple polymeric powders into the rotational molding mold. Such powders may have different colors as well as properties. For example, some polymeric powders may be placed in a rotational mold such that the innermost layer of wall 130 of watercraft 210 (analogous to layer 40) has a skin-foam-skin structure. Once polymeric powder has sufficiently melted and cooled, the mold is opened and the substantially finished polymeric watercraft hull or body is removed from the rotational molding mold. Final treatment including trimming and the optional addition of accessories is thereafter completed.

Processes 70, 110 and 310 enable the manufacturer of watercraft having a laminate reliably secured thereto without excess shrinkage of the laminate. Although processes 70 and 310 are described as utilizing an olefinic backing sheet and although process 110 is described as employing olefinic material including a reactive cross link adhesive, other bonding layers may alternatively be employed. For example, in lieu of utilizing a polar sheet having a layer of chlorinated polyolefin, process 110 may alternatively utilize other covalent or ionic adhesives which upon being activated attach to layer 40 to form a reliable bond between laminate 54 and layer 40. Similar materials may likewise be utilized in processes 70 and 310 in lieu of the backing sheet. Likewise, in alternative processes, the covalent adhesive may alternatively be initially adhered to layer 40 and then activated and adhered to laminate 54 which may or may not include layer 41 (process 70) or layer 42 (process 110).

Although processes 70, 110 and 310 have been described with respect to manufacturing watercraft such as canoes, kayaks and the like, processes 70, 110 and 310 are also well suited for manufacturing any of a variety large three-dimensional polymeric walled structures in which it would be desirable to provide such walled structures with either a glossy high-quality color or in which it would be desirable to provide such walled structures with a plurality of colors. Such colors could be arranged in different patterns or layouts such as camouflage. Moreover, such colors could be arranged in precise locations so as to provide the exterior surface with an overall image. Regardless of the exact large three-dimensional product being formed, processes 70, 110 and 310 produce a high-quality exterior appearance at a lower cost as compared to previous techniques.

Although the present invention has been described with reference to preferred embodiments, workers skilled in the art will recognize that changes may be made in form and detail without departing from the spirit and scope of the invention. Those skilled in the art will appreciate that certain of these advantages can be obtained separately through reconfiguring the foregoing structure without departing from the spirit and scope of the present invention. Because the technology of the present invention is relatively complex, not all changes in the technology are foreseeable. The present invention described with reference to the preferred embodiments and set forth in the following claims is manifestly intended to be as broad as possible. For example, unless specifically otherwise noted, the claims reciting a single particular element also encompass a plurality of such particular elements.

What is claimed is:

1. A method for forming a three-dimensional polymeric structure, the method comprising:
providing at least one paint layer;
providing a bonding layer coupled to the at least one paint layer to form an insert having a bonding surface provided by the bonding layer;
providing a mold having a hollow interior bounded by an interior surface;
positioning the insert within the interior along a portion of the interior surface;
depositing at least one charge of thermoplastic material into the interior;
heating the interior while rotating and rocking the mold, whereby the thermoplastic material melts and is deposited against the interior surface and the bonding surface of the insert to form a three-dimensional structure within the interior; and
removing the three-dimensional structure from the interior of the mold.

2. The method of claim 1, wherein the mold has a parting line formed by opposing mold edges and wherein a portion of the insert is positioned between the opposing mold edges.

3. The method of claim 2, wherein at least one of the opposing mold edges is insulated.

4. The method of claim 3, wherein at least one of the opposing mold edges is insulated by a removable insulating layer positioned over the at least one opposing mold edge.

5. The method of claim 4, wherein an insulating tape is applied to at least one of the opposing mold edges.

6. The method of claim 1 including supplying pressurized gas to the interior while rotating and rocking the mold.

7. The method of claim 6 including maintaining a pressure of at least about five pounds per square inch within the interior.

8. The method of claim 6 including maintaining a pressure of between about five pounds per square inch and about 16 pounds per square inch in the interior.

9. The method of claim 6 including:
sensing gas pressure within the interior; and
selectively venting gas from the interior based upon the sensed gas pressure.

10. The method of claim 1 including:
sensing gas pressure within the interior; and
selectively venting gas from the interior based upon the sensed gas pressure.

11. The method of claim 1 including venting gas from the interior at a rate such that gas pressure within the interior is large enough to maintain the insert in position along the portion of the interior surface and small enough so as to preserve integrity of the mold.

12. The method of claim 1 including applying a vacuum against the insert to maintain the insert in position along the portion of the interior surface.

13. The method of claim 1 including providing a translucent layer over the at least one paint layer, wherein the at least one paint layer is between the translucent layer and the bonding layer.

14. The method of claim 1 including providing an olefinic layer between the paint layer and the bonding layer.

15. The method of claim 14, wherein the olefinic layer is a reactive cross link adhesive with a polyolefin.

16. The method of claim 14, wherein the olefinic layer has a thickness of less than about 0.2 mils.

17. The method of claim 1, wherein the bonding layer has a thickness of at least about 2 mils.

18. The method of claim 1, wherein the bonding layer includes polyethylene.

19. The method of claim 1, wherein the at least one paint coat includes PVDF.

20. The method of claim 1 including providing a translucent layer including PVDF over the at least one paint layer, wherein the at least one paint layer is between the translucent layer and the bonding layer.

21. The method of claim 1, wherein the at least one paint layer includes a backing color and at least one additional color distinct from the backing color.

22. The method of claim 21, wherein the at least one additional distinct color is provided in a plurality of shapes.

23. The method of claim 21, wherein the plurality of shapes are distinct from one another.

24. The method of claim 23, wherein the plurality of shapes are in the shape of environmental vegetation.

25. The method of claim 1, wherein the mold interior is in the shape of a watercraft.

26. A method for forming a three-dimensional polymeric structure, the method comprising:
providing at least one paint layer coupled to a bonding layer so as to form an insert, the insert having a bonding surface provided by the bonding layer;
providing a mold having a hollow interior bounded by an interior surface, the mold having a parting line formed by opposing mold edges;
positioning the insert within the interior along a portion of the interior surface with a portion of the insert positioned between the opposing mold edges;
maintaining the opposing mold edges at a temperature less than the temperature of the remaining interior surface of the mold;
sensing gas pressure in the interior;
selectively exhausting and supplying gas from and into the interior based upon the sensed gas pressure to maintain the insert in position along the interior surface;
depositing at least one charge of polymeric material into the interior;
rotating and rocking the mold while the polymeric material is in a bondable condition to deposit the polymeric material against the interior surface of the mold and against the insert to form a three-dimensional structure within the interior; and
removing the three-dimensional structure from the interior of the mold.

27. A method for forming a three-dimensional polymeric structure, the method comprising:
providing a mold having a hollow interior bounded by an interior surface;
positioning an insert within the interior along a portion of the interior surface;
depositing at least one charge of polymeric material in the interior;
rotating and rocking the mold while the polymeric material is in a bondable condition, to deposit the polymeric material against the interior surface of the mold and against the insert from a three-dimensional structure within the interior; and
maintaining gas pressure within the interior high enough to maintain the insert in position along the interior surface and low enough so as to preserve integrity of the mold.

28. A method for forming a three-dimensional polymeric structure, the method comprising:
providing a mold having a hollow interior bounded by an interior surface, the mold having a part line formed by opposing mold edges;
positioning an insert within the interior along a portion of the interior surface with a portion of the insert extending between the opposing mold edges;
depositing at least one charge of polymeric material into the interior;
rotating and rocking the mold while the polymeric material is in a bondable condition to deposit the polymeric material against the interior surface of the mold and against the insert to form a three-dimensional structure within the interior; and
removing the three-dimensional structure from the interior of the mold.

29. The method of claim 28, wherein the polymeric material is a thermoplastic material and wherein the interior is heated to melt the thermoplastic material into a bondable condition.

30. The method of claim 28 including maintaining at least one of the opposing mold edges at a temperature less than the temperature of the remaining interior surface of the mold while the mold is rotating and rocking.

31. The method of claim 30 including insulating at least one of the opposing mold edges.

32. The method of claim 30 including cooling at least one of the opposing mold edges.
